(19) United States
(12) Patent Application Publication
(10) Pub. No.: US 2025/0210698 A1
(43) Pub. Date: Jun. 26, 2025

(54) SOLID IONICALLY CONDUCTIVE COMPOSITE CONTAINING AN ARGYRODITE STRUCTURE, ELECTROCHEMICAL CELL COMPRISING SAME

(71) Applicant: Solid Power Operating, Inc., Louisville, CO (US)

(72) Inventors: Brian E. FRANCISCO, Arvada, CO (US); Samuel M. OBERWETTER, Lafayette, CO (US)

(21) Appl. No.: 19/000,083

(22) Filed: Dec. 23, 2024

Related U.S. Application Data
(60) Provisional application No. 63/614,033, filed on Dec. 22, 2023.

(51) Int. Cl. H01M 10/0562

(52) U.S. Cl. CPC H01M 10/0562; H01M 2300/0068; H01M 2300/0085

(57) ABSTRACT

Processes for making sulfide-based solid electrolyte composites include mixing a lithium-containing material, a phosphorus-containing material, a sulfur-containing material, and a halogen-containing material in a solvent, removing the solvent, and then heat-treating the materials to form the sulfide-based solid electrolyte composites. The composites include an argyrodite component and second component, wherein each component has a unique x-ray diffraction pattern. The electrolyte composites may be incorporated into electrochemical cells, including solid-state batteries.

### CROSS-REFERENCE TO RELATED APPLICATION

This application is related to and claims priority under 35 U.S.C. § 119(e) from U.S. Patent Application No. 63/614,033 filed Dec. 22, 2023, titled “SOLID IONICALLY CONDUCTIVE COMPOSITE CONTAINING AN ARGYRODITE STRUCTURE, ELECTROCHEMICAL CELL COMPRISING SAME,” the entire contents of which is incorporated herein by reference for all purposes.

### FIELD OF THE DISCLOSURE

The present disclosure is directed toward solid electrolyte materials and electrochemical cells containing the solid electrolyte materials. Therefore, the disclosure relates to the fields of batteries, including solid-state batteries, electronics, chemistry, and materials science.

### BACKGROUND

As technologies around Li-ion batteries using liquid electrolytes reaches maturity, institutions are turning to solid-state batteries to push battery technology further. Solid-state batteries replace the liquid electrolytes with solid ionically conductive material that are used in forming the negative electrode, positive electrode and separator layers within the battery. Of the types of solid electrolyte materials available, the sulfide class of solid electrolytes has drawn interest due to having a high ionic conductivity and processability when forming battery components.

A specific group of sulfide solid electrolyte materials that has gained interest is the “argyrodite” solid electrolyte, or, more specifically, solid electrolyte materials having an argyrodite crystal structure. These lithium argyrodite materials can be expressed by the general formula Li⁺₍₁₂₋ₙ₋ₓ₎Bⁿ⁺X₆₋ₓ²⁻Yₓ⁻, where Bⁿ⁺is selected from the group consisting of P, As, Ge, Ga, Sb, Si, Sn, Al, In, Ti, V, Nb, and Ta, X²⁻is selected from the group consisting of S, Se, and Te, Y⁻is selected from the group consisting of Cl, Br, I, F, CN, OCN, SCN, and N₃, and 0≤x≤2. These argyrodite materials have ionic conductivities on par with standard liquid electrolytes; however, materials with the argyrodite crystal structure tend to have high material hardness. This material hardness prevents the formation of ideal contact between electrolyte compounds and electrode active materials used in the positive or negative electrode layers. To overcome this material constraint, an electrolyte with an argyrodite structure can be physically mixed with another material having a more ideal material hardness such as a Li₇P₃S₁₁ electrolyte material. To perform physical mixing, milling or grinding devices are used to ensure a homogeneous composite is formed. However, the milling of the composite causes a reduction in crystallinity of the electrolyte material with an argyrodite structure causing ionic conductivity to decrease. The newly formed composite may be heated to reform the argyrodite crystal structure. Unfortunately, the temperature needed to reform the argyrodite structure is higher than the decomposition temperature of the Li₇P₃S₁₁ material. Using this approach will reform the argyrodite structure but the decomposition products of the Li₇P₃S₁₁ material results in the formation of a composite with even lower ionic conductivity.

It is with these observations in mind, among others, that aspects of the present disclosure were conceived.

### SUMMARY

Provided herein are processes for forming sulfide-based solid electrolytes. The processes generally include forming a mixture comprising a solvent, a phosphorous-containing material, a lithium-containing material, a sulfur-containing material, and a halogen-containing material, wherein the phosphorous-containing material is present in a stoichiometric excess as compared to the lithium-containing material; removing the solvent to form a powder; and heating the powder to form the sulfide-based solid electrolyte composite. In some embodiments, the solvent includes a polar solvent, such as ethanol. In some embodiments, the phosphorous-containing material includes P₄S₃. In some embodiments, the lithium-containing material includes Li₂S.

Further provided herein are solid electrolyte composites made from the processes described herein. The solid electrolytes include two unique phases detectable using x-ray diffractometry. The solid electrolyte composites include a first component comprising lithium, phosphorus, sulfur, and a halogen, and having an argyrodite structure with x-ray diffraction (XRD) peaks at 2θ=25.6°±0.5°, 30.0°±0.5°, and 31.4°±0.5° with Cu−Kα(1,2)=1.5418 Å; and a second component comprising lithium, phosphorus, and sulfur, and having XRD peaks at 2θ=20.9°±0.5° and 31°±0.5° with Cu−Kα(1,2)=1.5418 Å.

Further provided herein are solid-state batteries that include the solid electrolyte composites described herein. The solid-state batteries include an anode layer, a cathode layer, or a separator layer comprising a solid electrolyte composite, the solid electrolyte composite comprising a first component and a second component, wherein the first component has an Argyrodite structure with x-ray diffraction (XRD) peaks at 2θ=25.6°±0.5°, 30.0°±0.5°, and 31.4°±0.5°, and the second component has XRD peaks at 2θ=20.9°±0.5°, 31°±0.5° and 33°±0.5 with Cu−Kα(1,2)=1.5418 Å.

### BRIEF DESCRIPTION OF THE FIGURES

The present disclosure may be understood by reference to the following detailed description taken in conjunction with the drawings briefly described below.

FIG. 1 shows an x-ray diffraction (XRD) plot of intensity (counts) versus diffraction angle (degrees 2-theta (2θ)), showing the results of XRD measurements using Cu−Kα(1,2)=1.5418 Å radiation performed on a solid electrolyte composite prepared according to Example 1.

### DETAILED DESCRIPTION

Before various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

The indefinite articles “a” and “an,” as used herein in the specification and in the claims, unless clearly indicated to the contrary, should be understood to mean “at least one.”

The present disclosure is directed to a process for making a sulfide-based solid electrolyte composite using a phosphorus material including P₄S₃ compound and is used in stoichiometric excess. Applicant has surprisingly discovered that the process forms a sulfide solid electrolyte composite containing an argyrodite structure having high ionic conductivity (e.g., greater than 1 mS) and low material hardness. The sulfide-based solid electrolyte composite contains an argyrodite component having an argyrodite-type structure comprising lithium (Li), phosphorus (P), sulfur (S), and a halogen (X). The sulfide-based solid electrolyte composite further contains a second component comprising lithium (Li), phosphorus (P), and oxygen (O), and has peak positions of 2θ=20.9°±0.5°, 31°±0.5°, and 33°±0.5° in an X-ray diffraction pattern measured by an X-ray diffraction (XRD) apparatus using CuKal rays. In some embodiments, the second component may also contain sulfur (S). In some embodiments, the second component may also include a halogen. The sulfide solid electrolyte composite may be an ideal material to pair with the electrode active material used in the positive or negative electrode layers of a solid-state electrochemical cell, such as a solid-state battery. The sulfide solid electrolyte compound may also be used in the separator layer of a solid-state battery.

### I. Process

The process comprises forming a mixture of precursors and a solvent, removing the solvent from the mixture to form a powder, and then heat-treating the powder to form a solid electrolyte composite. The precursors include a lithium-containing material, a phosphorous-containing material, a sulfur-containing material, an oxygen-containing material, and a halogen-containing material. It should be understood that one precursor may fall into multiple precursor categories listed in the previous sentence. For example, LiCl may be considered both a lithium-containing material and a halogen-containing material. The phosphorous-containing material is used in a stoichiometric excess (i.e., from about 10% to about 30% molar excess, or about 20% molar excess) as compared to the lithium-containing material, while all other materials are used in stoichiometric equivalents. The precursors further include a sulfur-containing material, and a halogen-containing material. All of the precursors are mixed in a desired amount and heat-treated in an inert atmosphere to prepare a solid electrolyte composite. The inert atmosphere may be a vacuum, or an area filled with an inert gas such as nitrogen or argon.

The step of forming the mixture (i.e., mixing) may include milling or pulverization. In some embodiments, the milling includes ball milling. The milling may include dry milling (i.e., milling without a solvent) or wet milling (milling in the presence of a solvent).

In some embodiments, the step of forming the mixture may include processes such as dissolution using one or more solvents may be used to form the precursor mixture. In some embodiments, a polar solvent or a combination of polar and non-polar solvents may be employed. When using the dissolution process, the precursors and one or more solvents is added to a container such that the one or more solvents contact the precursors. When the one or more solvents contacts the precursors, one or more of the precursors may dissolve, thereby forming a solution.

The mixing may take place for a duration from about 1 minute to about 48 hours. For example, the mixing may take place for a duration from about 1 minute to about 10 minutes, about 1 minute to about 30 minutes, about 1 minute to about 1 hour, about 1 minute to about 2 hours, about 1 minute to about 4 hours, about 1 minute to about 8 hours, about 1 minute to about 12 hours, about 1 minute to about 24 hours, about 1 minute to about 48 hours, about 10 minutes to about 48 hours, about 30 minutes to about 48 hours, about 1 hour to about 48 hours, about 2 hours to about 48 hours, about 4 hours to about 48 hours, about 8 hours to about 48 hours, about 12 hours to about 48 hours, or about 24 hours to about 48 hours. As another example, the mixing may take place for a duration of about 1 minute, 5 minutes, 10 minutes, 15 minutes, 30 minutes, 45 minutes, 1 hour, 2 hours, 3 hours, 4 hours, 5 hours, 6 hours, 7 hours, 8 hours, 9 hours, 10 hours, 15 hours, 20 hours, 25 hours, 30 hours, 35 hours, 40 hours, 45 hours, or about 48 hours.

The mixing temperature is not limited so long as it does not cause the solvent or any of the precursors to boil or melt. In some embodiments, the mixing may be accomplished at room temperature, e.g., from about 20° C. to about 30° C.

After the mixture is formed, the one or more solvents is removed by vacuum or heating, thereby forming a powder. Alternatively, the solvent may be removed by simply allowing the mixture to dry at room temperature to allow the solvent to evaporate. The temperature of the heating during drying may be up to about 100° C. This may be accomplished using a furnace, oven, vacuum oven, or other apparatuses known in the art.

Once the one or more solvents are removed, the precursors may be heat treated to a point at which a crystalline solid electrolyte composite is formed. The heat treatment may be performed at a temperature from about 200° C. to about 700° C. for a duration from about 30 minutes to about 36 hours. For example, the heat treatment may be performed at a temperature from about 200° C. to about 300° C., about 200° C. to about 400° C., about 200° C. to about 500° C., about 200° C. to about 600° C., about 200° C. to about 700° C., about 300° C. to about 700° C., about 400° C. to about 700° C., about 500° C. to about 700° C., or about 600° C. to about 700° C. As another example, the heat treatment may be performed at a temperature of about 200° C., 250° C., 300° C., 350° C., 400° C., 450° C., 500° C., 550° C., 600° C., 650° C., or about 700° C.

The heat treatment may be performed for a duration from about 30 minutes to about 36 hours. For example, the heat treatment may be performed for a duration from about 30 minutes to about 1 hour, about 30 minutes to about 2 hours, about 30 minutes to about 4 hours, about 30 minutes to about 8 hours, about 30 minutes to about 12 hours, about 30 minutes to about 24 hours, about 30 minutes to about 36 hours, about 1 hour to about 36 hours, about 2 hours to about 36 hours, about 4 hours to about 36 hours, about 8 hours to about 36 hours, about 12 hours to about 36 hours, or about 24 hours to about 36 hours. As another example, the heat treatment may be performed for a duration of about 30 minutes, 45 minutes, 1 hour, 2 hours, 3 hours, 4 hours, 5 hours, 6 hours, 7 hours, 8 hours, 9 hours, 10 hours, 15 hours, 20 hours, 25 hours, 30 hours, 35 hours, or about 36 hours.

The one or more solvents may include a polar solvent. Polar solvents may be ethers, nitriles, esters, or alcohols. Importantly, these solvents contain oxygen atoms that may be incorporated into the solid electrolyte composite when forming the precursor mixture.

The polar solvent may include an alcohol. The alcohol solvent may include methanol, ethanol, n-propanol, ispropanol, n-butanol, isobutanol, tert-butanol, and other alcohol solvents known in the art, or any combination thereof. In a preferred embodiment, the polar solvent may include ethanol.

The solvent may include ethers. Examples of ethers suitable for use in the methods described herein include tetrahydrofuran, diethyl ether, dibutyl ether, dipentyl ether, dimethoxyethane (DME), dioxane, anisole, and combinations thereof, as well as other ethers known in the art.

The solvent may include esters. Examples of esters suitable for use in the methods described herein include ethyl acetate, ethyl butyrate, isobutyl acetate, butyl acetate, butyl butyrate and butyl propanoate, and combinations thereof, as well as other esters known in the art.

The solvent may include nitriles. Examples of nitriles suitable for use in the methods described herein include acetonitrile, propionitrile, butyronitrile, isobutyronitrile, and combinations thereof, as well as other nitriles known in the art.

The one or more solvents may include a non-polar solvent. Non-polar solvents may include hydrocarbon solvents, including alkanes, alkenes, and alkynes. The hydrocarbon solvents may be linear, branched, or cyclic. Non-limiting examples of non-polar solvents that may be used include heptane, octane, xylenes, toluene, and benzene, heptane, octane, xylenes, toluene, and benzene.

The lithium-containing material may include Li₂S, Li₂SO₄, LiOH, Li₂CO₃, Li₂O, Li₃N, or any combination thereof.

The phosphorus-containing material includes P₄S₃. In some additional embodiments, the phosphorus-containing material may further include P₄S₁₀ (P₂S₅), P₄S₉, P₄S₇, P₄Sₓ where X is greater than 10, or any combination thereof. In some additional embodiments, the phosphorus-containing material may include P₃N₅.

In some embodiments, the sulfur-containing material may include elemental sulfur, Na₂Sₓ, K₂Sₓ, Li₂Sₓ where X is greater than 1 but less than 8, NaSH, LiSH, or any combination thereof. In some examples, the sulfur-containing material may include Na₂S, K₂S, or Li₂S.

In some embodiments, the halogen-containing material may include LiF, LiCl, LiBr, LiI, LiClₓBr_{y} where 0<x<1, 0<y<1, and x+y=1, or any combination thereof. The halogen-containing material may alternatively include a pseudohalogen, such as LiBH₄, LiBF₄, LiNH₂, LiNO₃, LiCN, LiOH, LiSCN, LiSH, or any combination thereof.

In some embodiments, the precursors may additionally include SiS₂, GeS₂, B₂S₃, or any combination thereof.

### II. Sulfide-Based Solid Electrolyte Composite

The sulfide-based solid electrolyte composite of the present disclosure has a crystal structure defined by a unique XRD peak profile and contains at least lithium, phosphorous, sulfur and halogen elements. The sulfide-based solid electrolyte composite includes a first component having an argyrodite crystal structure and a second component.

In some embodiments, the sulfide-based solid electrolyte composite may further have distinct XRD peaks located at 2θ=25.6°±0.5°, 30.0°±0.5°, or 31.4°±0.5° with Cu−Kα(1,2)=1.5418 Å, which correspond to the argyrodite crystal structure of the argyrodite component of the solid electrolyte composite. Electrolyte compounds with an argyrodite crystal structure have an XRD peak at 2θ=25.6°±0.5° with a peak intensity referred to herein as I_{X}, an XRD peak at 2θ=30.0°±0.5° with a peak intensity referred to as I_{Y}, and an XRD peak at 2θ=31.4°±0.5° with a peak intensity referred to as I_{Z}.

The argyrodite crystal structure of the argyrodite component of the solid electrolyte composite may have a formula Li_{(7-w-z)}PS₍6−w−z)X_{w}Y_{z}, wherein X and Y are each a halogen or a pseudohalogen, wherein 0≤w≤2, 0≤z≤2, and w+z=2. In some embodiments when X and/or Y is a halogen, the halogen may be selected from the group consisting of fluorine (F), chlorine (Cl), bromine (Br), Iodine (I), or combinations thereof. In some embodiments when X and/or Y is a pseudohalogen, the pseudohalogen may include borohydride (BH₄), fluoroborate (BF₄), azanide (NH₂), nitrogen trioxide (NO₃), cyanide (CN), hydroxide (OH), thiocyanate (SCN), hydrosulfide (SH), and other pseudohalogens known in the art and combinations thereof.

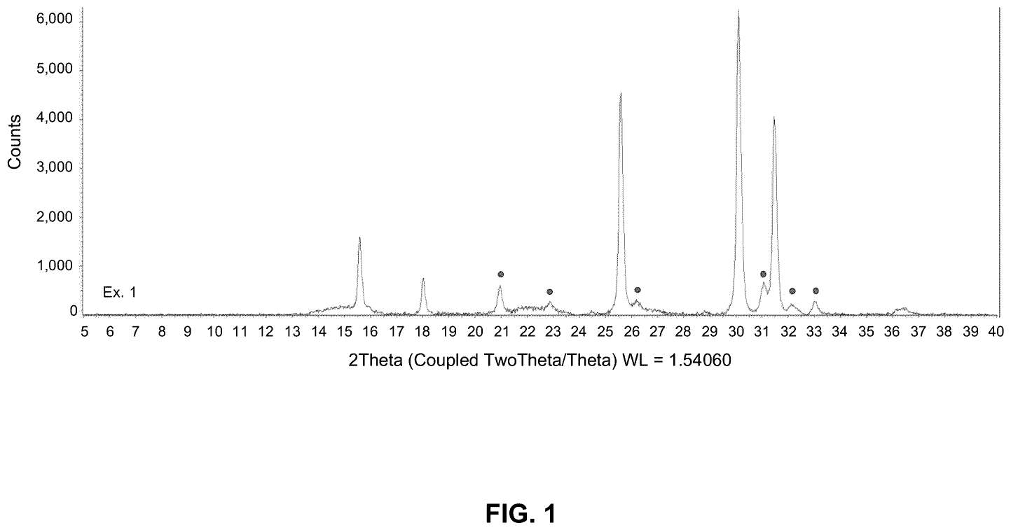

The sulfide-based solid electrolyte composite of the present disclosure contains distinct XRD peaks that are located at 2θ=20.9°±0.5°, 31°±0.5°. and 33°÷0.5°, as shown in FIG. 1 with Cu−Kα(1,2)=1.5418 Å, which correspond to the second component of the solid electrolyte composite. In some embodiments, the sulfide-based solid electrolyte composite may have additional distinct XRD peaks located at 2θ=22.8°±0.5°, 26.2°±0.5°, or 32.1°±0.5° with Cu−Kα(1,2)=1.5418 Å which may also correspond to the second component of the solid electrolyte composite. Each of the XRD peaks correspond to peak intensities and may be expressed by the area under the curve for any given peak. For example, the XRD peak at 2θ=20.9°±0.5° exhibits a peak intensity of I_{A}, the XRD peak at 31°±0.5° has a peak intensity of I_{B}, and the XRD peak at 33°±0.5° has a peak intensity of I_{C}.

In some embodiments, the intensity of the peak at 20.9°±0.5° (I_{A}) may be greater than the intensity of the peak at 33°±0.5° (I_{C}). This difference in peak intensities may be expressed by the formula: I_{A}>I_{C}. In some additional embodiments, the intensity of the peak at 31°±0.5° (I_{B}) may be greater than the intensity of the peak at 33°±0.5° (I_{C}). The difference in peak intensities may be expressed by the formula: I_{B}>I_{C}.

In some embodiments, the sulfide-based solid electrolyte composite of the present disclosure has an XRD peak at 2θ=20.9°±0.5° with a peak intensity of I_{A}, and an XRD peak at 30.0°±0.5° with a peak intensity of I_{Y}. The ratio between the XRD peak intensity of the peak at 20.9°±0.5° (I_{A}) and the XRD peak intensity of the peak at 30.0°±0.5° (I_{Y}) follows the formula I_{A}:I_{Y}>0.

In some embodiments, the sulfide-based solid electrolyte composite of the present disclosure has an XRD peak at 20.9°±0.5° with a peak intensity of I_{A}, and an XRD peak at 30.0°±0.5° with a peak intensity of I_{Y}. The ratio between the XRD peak intensity of the peak at 20.9°±0.5° (I_{A}) and the XRD peak intensity of the peak at 30.0°÷0.5° (I_{Y}) follows the formula I_{A}:I_{Y} is ≤1 but >0.

### III. Solid-State Batteries

The sulfide-based solid electrolyte composites of the present disclosure may be incorporated into a solid-state battery. The sulfide-based solid electrolyte composite may be included in one or both electrode layers of the solid-state battery (i.e., the cathode layer or anode layer, or both). Additionally or alternatively, the sulfide-based solid electrolyte composite may be included in the separator layer of the solid-state battery.

The solid-state includes a first current collector, a cathode layer, a separator layer, an anode layer, and a second current collector. The cathode layer is disposed between the first current collector and the separator layer. The separator layer is disposed between the cathode layer and the anode layer. The anode layer is disposed between the separator layer and the second current collector.

The first current collector and the second current collector may include copper, aluminum, nickel, titanium, stainless steel, magnesium, iron, zinc, indium, germanium, silver, platinum, gold, or any combination thereof.

The solid-state battery may include an anode layer that includes a sulfide-based solid electrolyte composite of the present disclosure. The anode layer further includes an anode active material, and may also include a binder and a conductive additive.

The sulfide-based solid electrolyte composite may be present in the anode layer in an amount from greater than 0% to about 60% by weight of the anode layer. For example, the sulfide-based solid electrolyte composite may be present in the anode layer in an amount from greater than 0% to about 10%, greater than 0% to about 20%, greater than 0% to about 30%, greater than 0% to about 40%, greater than 0% to about 50%, about 10% to about 60%, about 20% to about 60%, about 30% to about 60%, about 40% to about 60%, or about 50% to about 60% by weight of the anode layer. In some aspects, the sulfide-based solid electrolyte composite may be present in the anode layer in an amount of about 5%, 10%, 15%, 20%, 25%, 30%, 35%, 40%, 45%, 50%, 55%, or 60% by weight of the anode layer.

The anode active material preferably is an inorganic material. The anode active material may include one or more inorganic materials such as silicon (Si), silicon alloys, tin (Sn), tin alloys, germanium (Ge), germanium alloys, graphite, Li₄Ti₅O₁₂ (LTO), other known anode active materials, or any combination thereof.

The anode active material may be present in the anode layer in an amount from about 30% to about 99.9% by weight of the anode layer. In some aspects, the anode active material may be present in the anode layer in an amount from about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the anode layer. In some aspects, the anode active material may be present in the anode layer in an amount of about 30%, 35%, 40%, 45%, 50%, 55%, 60%, 65%, 70%, 75%, 80%, 85%, 90%, 91%, 92%, 93%, 94%, 95%, 96%, 97%, 98%, 99% or about 99.9% by weight of the anode layer.

The binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly (vinylene difluoride-hexafluoropropylene) copolymer (PVDF-HFP), and the like. In another embodiment, the binder may include a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may include an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be include a polycondensation polymer such as but not limited to polyurea, polyamide paper, polyimide, polyester, and the like. In yet a further embodiment, the binder may include a nitrile rubber such as but not limited to acrylonitrile-butadiene rubber (ABR), polystyrene nitrile-butadiene rubber (PS-NBR), and mixtures thereof.

In some embodiments, the binder may include a high molecular weight binder and a low molecular weight binder. The high molecular weight binder may be the same species of binder as the low molecular weight binder, or it may be different. The high molecular weight binder has a longer polymer chain as compared to the low molecular weight binder. High molecular weight binders, as described herein, have a molecular weight of about 300,000 g/mol or higher. Low molecular weight binders, as described herein, have a molecular weight of about 100,000 g/mol or lower.

The binder may be present in the anode layer in an amount from about 1% to about 30% by weight of the anode layer. For example, the binder may be present in the anode layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the anode layer. As another example, the binder may be present in the anode layer in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or about 30%.

The conductive additive may include metal powders, fibers, filaments, or any other material known to conduct electrons. The conductive additive may comprise a carbon-based conductive additive, such as carbon fiber, graphite, graphene, carbon black, conductive carbon, amorphous carbon, vapor grown carbon fiber (VGCF), carbon nanotubes, carbon nanowires, activated carbon, and combinations thereof.

The conductive additive may be present in the anode layer in an amount from greater than 0% to about 15% by weight. In some aspects, the conductive additive may be present in the anode layer in an amount from greater than 0% to about 10%, or greater than 0% to about 5% by weight. In some additional aspects, the conductive additive may be present in the anode layer in an amount of about 0%, 1%, 2%, 3%, 4%, 5%, 6%, 7%, 8%, 9%, 10%, 11%, 12%, 13%, 14%, or about 15% by weight. In an example, the conductive additive is present in the anode layer in an amount from greater than 0% to about 5% by weight.

The solid-state battery may include a cathode layer that includes a sulfide-based solid electrolyte composite of the present disclosure. The cathode layer further includes a cathode active material, and may also include a binder and a conductive additive. The binder and the conductive additive may be any of those described above with respect to the anode layer.

The cathode active material may include nickel-manganese-cobalt (“NMC”) which can be expressed as Li(NiₐCO_{b}Mn_{c})O₂(0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂) or a combination thereof. In another embodiment, the cathode active material may include a coated or uncoated metal oxide, such as but not limited to V₂O₅, V₆O₁₃, MoO₃, LiCoO₂, LiNiO₂, LiMnO₂, LiMn₂O₄, LiNi_{1-Y}CO_{Y}O₂, LiCO_{1-Y}Mn_{Y}O₂, LiNi_{1-Y}Mn_{Y}O₂(0≤Y<1), Li(NiₐCO_{b}Mn_{c})O₄(0<a<2, 0<b<2, 0<c<2, a+b+c=2), LiMn_{2-Z}Ni_{Z}O₄, LiMn_{2-Z}Co_{Z}O₄(0<Z<2), LiCoPO₄, LiFePO₄, CuO, Li(NiₐCo_{b}Al_{c})O₂(0<a<1, 0<b<1, 0<c<1, a+b+c=1) or any combination thereof. In yet another embodiment, the cathode active material may include a coated or uncoated metal sulfide such as but not limited to titanium sulfide (TiS₂), molybdenum sulfide (MoS₂), iron sulfide (FeS, FeS₂), copper sulfide (CuS), nickel sulfide (Ni₃S₂), or any combination thereof. In still further embodiments, the cathode active material may include elemental sulfur (S). In additional embodiments, the cathode active material may include a fluoride cathode active material such as but not limited to lithium fluoride (LiF), sodium fluoride (NaF), calcium fluoride (CaF₂), magnesium fluoride (MgF₂), nickel (II) fluoride (NiF₂), iron (III) fluoride (FeF₃), vanadium (III) fluoride (VF₃), cobalt (III) fluoride (CoF₃), chromium (III) fluoride (CrF₃), manganese (III) fluoride (MnF₃), aluminum fluoride (AlF₃), and zirconium (IV) fluoride (ZrF₄), or any combination thereof.

The cathode active material may be present in the cathode layer in an amount from about 30% to about 98% by weight of the cathode layer. In some aspects, the cathode active material may be present in the cathode layer in an amount from about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the cathode layer. In some aspects, the cathode active material may be present in the cathode layer in an amount of about 30%, 35%, 40%, 45%, 50%, 55%, 60%, 65%, 70%, 75%, 80%, 85%, 90%, 91%, 92%, 93%, 94%, 95%, 96%, 97%, or about 98% by weight of the cathode layer.

The sulfide-based solid electrolyte composite may be present in the cathode layer in an amount from greater than 0% to about 60% by weight of the cathode layer. For example, the sulfide-based solid electrolyte composite may be present in the cathode layer in an amount from greater than 0% to about 10%, greater than 0% to about 20%, greater than 0% to about 30%, greater than 0% to about 40%, greater than 0% to about 50%, about 10% to about 60%, about 20% to about 60%, about 30% to about 60%, about 40% to about 60%, or about 50% to about 60% by weight of the cathode layer. In some aspects, the sulfide-based solid electrolyte composite may be present in the cathode layer in an amount of about 5%, 10%, 15%, 20%, 25%, 30%, 35%, 40%, 45%, 50%, 55%, or 60% by weight of the cathode layer.

The binder may be present in the cathode layer in an amount from about 1% to about 30% by weight of the cathode layer. For example, the binder may be present in the cathode layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the cathode layer. As another example, the binder may be present in the cathode layer in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or about 30%.

The conductive additive may be present in the cathode layer in an amount from greater than 0% to about 15% by weight. In some aspects, the conductive additive may be present in the cathode layer in an amount from greater than 0% to about 10%, or greater than 0% to about 5% by weight. In some additional aspects, the conductive additive may be present in the cathode layer in an amount of about 0%, 1%, 2%, 3%, 4%, 5%, 6%, 7%, 8%, 9%, 10%, 11%, 12%, 13%, 14%, or about 15% by weight. In an example, the conductive additive is present in the cathode layer in an amount from greater than 0% to about 5% by weight.

The solid-state battery may include a separator layer that includes a sulfide-based solid electrolyte composite of the present disclosure. The separator layer may further include a binder and a conductive additive. The binder and the conductive additive may be any of those described above with respect to the anode layer.

The sulfide-based solid electrolyte composite may be present in the separator layer in an amount from about 50% to about 99% by weight of the separator layer. For example, the sulfide-based solid electrolyte composite may be present in the separator layer in an amount from about 50% to about 60%, about 50% to about 70%, about 50% to about 80%, about 50% to about 90%, about 50% to about 95%, about 50% to about 99%, about 60% to about 99%, about 70% to about 99%, about 80% to about 99%, about 90% to about 99%, or about 95% to about 99%.

The binder may be present in the separator layer in an amount from about 1% to about 30% by weight of the separator layer. For example, the binder may be present in the separator layer in an amount from about 1% to about 5%, about 1% to about 10%, about 1% to about 15%, about 1% to about 20%, about 1% to about 25%, about 1% to about 30%, about 5% to about 30%, about 10% to about 30%, about 15% to about 30%, about 20% to about 30%, about 25% to about 30%, about 5% to about 15%, about 5% to about 20%, about 10% to about 15%, about 10% to about 20%, or about 15% to about 20% by weight of the separator layer. As another example, the binder may be present in the separator layer in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or about 30%.

The conductive additive may be present in the anode layer in an amount from greater than 0% to about 15% by weight. In some aspects, the conductive additive may be present in the anode layer in an amount from greater than 0% to about 10%, or greater than 0% to about 5% by weight. In some additional aspects, the conductive additive may be present in the anode layer in an amount of about 0%, 1%, 2%, 3%, 4%, 5%, 6%, 7%, 8%, 9%, 10%, 11%, 12%, 13%, 14%, or about 15% by weight. In an example, the conductive additive is present in the anode layer in an amount from greater than 0% to about 5% by weight. In some embodiments, the separator layer does not include a conductive additive.

### Enumerated Embodiments

Embodiment 1: A process for forming a sulfide-based solid electrolyte composite comprising:
forming a mixture comprising a solvent, a phosphorous-containing material, a lithium-containing material, a sulfur-containing material, and a halogen-containing material, wherein the phosphorous-containing material is present in a stoichiometric excess as compared to the lithium-containing material;
removing the solvent to form a powder; and
heating the powder to form the sulfide-based solid electrolyte composite.

Embodiment 2: The process of embodiment 1, wherein the solvent comprises an alcohol.

Embodiment 3: The process of embodiment 2, wherein the solvent comprises ethanol.

Embodiment 4: The process of any one of embodiments 1-3, wherein the phosphorous-containing material comprises P₄S₃.

Embodiment 5: The process of any one of embodiments 1-4, where the lithium-containing material comprises Li₂S.

Embodiment 6: A process for forming a sulfide-based solid electrolyte composite comprising:
forming a mixture comprising a polar solvent, a phosphorous-containing material, a lithium-containing material, a sulfur-containing material, and a halogen-containing material, wherein the phosphorous-containing material is present in a stoichiometric excess as compared to the lithium-containing material;
removing the polar solvent to form a powder; and
heating the powder to form the sulfide-based solid electrolyte composite.

Embodiment 7: The process of embodiment 6, wherein forming the mixture further comprises milling the mixture.

Embodiment 8: The process of embodiment 6 or 7, wherein the phosphorous-containing material comprises P₄S₃.

Embodiment 9: A solid electrolyte composite comprising a first component and a second component, the composite formed by the process of any one of embodiments 1-8.

Embodiment 10: The solid electrolyte composite of embodiment 9, wherein the first component has an argyrodite structure with x-ray diffraction (XRD) peaks at 2θ=25.6°±0.5°, 30.0°±0.5°, and 31.4°±0.5° with Cu−Kα(1,2)=1.5418 Å.

Embodiment 11: The solid electrolyte composite of embodiment 10, wherein the second component has XRD peaks at 2θ=20.9°±0.5° and 31°±0.5° with Cu−Kα(1,2)=1.5418 Å.

Embodiment 12: The solid electrolyte composite of embodiment 11, wherein the second component has an additional XRD peak at 2θ=33°±0.5 with Cu−Kα(1,2)=1.5418 Å

Embodiment 13: The solid electrolyte composite of embodiment 11, wherein the XRD peak at 2θ=20.9°±0.5° has a peak intensity of I_{A}, the XRD peak at 2θ=30.0°±0.5° has a peak intensity of I_{Y}, and I_{A}:I_{Y} is >0.

Embodiment 14: A sulfide-based solid electrolyte composite comprising:
a first component comprising lithium, phosphorus, sulfur, and a halogen, and having an argyrodite structure with x-ray diffraction (XRD) peaks at 2θ=25.6°±0.5°, 30.0°±0.5°, and 31.4°±0.5° with Cu−Kα(1,2)=1.5418 Å; and
a second component comprising lithium, phosphorus, and sulfur, and having XRD peaks at 2θ=20.9°±0.5° and 31°±0.5° with Cu−Kα(1,2)=1.5418 Å.

Embodiment 15: The sulfide-based solid electrolyte composite of embodiment 14, wherein the XRD peak at 2θ=20.9°±0.5° has a peak intensity of I_{A}, and the XRD peak at 2θ=30.0°±0.5° has a peak intensity of I_{Y}, wherein I_{A}:I_{Y} is >0.

Embodiment 16: The sulfide-based solid electrolyte composite of embodiment 15, wherein 1≥I_{A}:I_{Y}>0.

Embodiment 17: The sulfide-based solid electrolyte composite of any one embodiments 14-16, wherein the XRD peak at 20=31°±0.5° has a peak intensity of I_{B}, and the XRD peak at 20=33°±0.5° has a peak intensity of I_{C}, wherein I_{B}>I_{C}.

Embodiment 18: A solid-state battery including an anode layer, a cathode layer, or a separator layer comprising a solid electrolyte composite, the solid electrolyte composite comprising a first component and a second component, wherein the first component has an Argyrodite structure with x-ray diffraction (XRD) peaks at 2θ=25.6°±0.5°, 30.0°±0.5°, and 31.4°±0.5°, and the second component has XRD peaks at 2θ=20.9°±0.5°, 31°±0.5° and 33°±0.5 with Cu−Kα(1,2)=1.5418 Å.

Embodiment 19: The solid-state battery of embodiment 18, wherein the solid electrolyte composite comprises lithium, sulfur, phosphorous and a halogen selected from the group consisting of Cl, Br, I, and combinations thereof.

Embodiment 20: The solid-state battery of embodiment 18 or embodiment 19, wherein the XRD peak at 2θ=20.9°±0.5° has a peak intensity of I_{A}, and the XRD peak at 2θ=30.0°±0.5° has a peak intensity of I_{Y}, and where I_{A}:I_{Y} is >0.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1

0.1905 g of LiCl, 0.5157 g of Li₂S, 0.2995 g of P₄S₃, and 0.6239 g of elemental sulfur were placed in a 50 mL vial together with 20 mL of anhydrous ethanol. The contents of the vial were mixed for 30 minutes, after which the solvent was removed by placing the solution in vacuum environment and heated to 140° C., forming a composite Any residual solvent was then removed from the composite. The composite was then heated to 450° C. for 1 hour. The resultant material was a powder. An XRD plot was taken. A representation of that plot appears in FIG. 1.

The resultant power was a solid electrolyte composite containing an argyrodite structure. This solid electrolyte composite had an ionic conductivity of 1.46 mS and was thermally stable up to a temperature of at least 450° C. As shown in FIG. 1, the solid electrolyte composite had XRD peaks at 2θ=20.9°, 31.1°, and 33.1° with Cu−Kα(1,2)=1.5418 Å, which are marked by the (●) symbol. FIG. 1 further shows that this material had XRD peaks at 2θ=22.8°, 26.3°, and 32.2° with Cu−Kα(1,2)=1.5418 Å. The unmarked peaks belong to the argyrodite structure having XRD peaks at 25.6°, 30.2°, and 31.4° with Cu−Kα(1,2)=1.5418 Å.

Further, the XRD peak at 20.9°±0.5° had a peak intensity (I_{A}) and the XRD peak at 30.0°±0.5° belonging to the argyrodite structure had a peak intensity (I_{Y}). Comparing the two peak intensities, it is shown that I_{A}:I_{Y} is >0.

What is claimed is:

1. A process for forming a sulfide-based solid electrolyte composite comprising:
forming a mixture comprising a solvent, a phosphorous-containing material, a lithium-containing material, a sulfur-containing material, and a halogen-containing material, wherein the phosphorous-containing material is present in a stoichiometric excess as compared to the lithium-containing material;
removing the solvent to form a powder; and
heating the powder to form the sulfide-based solid electrolyte composite.

2. The process of claim 1, wherein the solvent comprises an alcohol.

3. The process of claim 2, wherein the solvent comprises ethanol.

4. The process of claim 1, wherein the phosphorous-containing material comprises P₄S₃.

5. The process of claim 1, where the lithium-containing material comprises Li₂S.

6. A process for forming a sulfide-based solid electrolyte composite comprising:
forming a mixture comprising a polar solvent, a phosphorous-containing material, a lithium-containing material, a sulfur-containing material, and a halogen-containing material, wherein the phosphorous-containing material is present in a stoichiometric excess as compared to the lithium-containing material;
removing the polar solvent to form a powder; and
heating the powder to form the sulfide-based solid electrolyte composite.

7. The process of claim 6, wherein forming the mixture further comprises milling the mixture.

8. The process of claim 6, wherein the phosphorous-containing material comprises P₄S₃.

9. A solid electrolyte composite comprising a first component and a second component, the composite formed by the process of claim 1.

10. The solid electrolyte composite of claim 9, wherein the first component has an argyrodite structure with x-ray diffraction (XRD) peaks at 2θ=25.6°±0.5°, 30.0°±0.5°, and 31.4°±0.5° with Cu−Kα(1,2)=1.5418 Å.

11. The solid electrolyte composite of claim 10, wherein the second component has XRD peaks at 2θ=20.9°±0.5° and 31°±0.5° with Cu−Kα(1,2)=1.5418 Å.

12. The solid electrolyte composite of claim 11, wherein the second component has an additional XRD peak at 2θ=33°±0.5 with Cu−Kα(1,2)=1.5418 Å

13. The solid electrolyte composite of claim 11, wherein the XRD peak at 2θ=20.9°±0.5° has a peak intensity of I_{A}, the XRD peak at 2θ=30.0°±0.5° has a peak intensity of I_{Y}, and I_{A}:I_{Y} is >0.

14. A sulfide-based solid electrolyte composite comprising:
a first component comprising lithium, phosphorus, sulfur, and a halogen, and having an argyrodite structure with x-ray diffraction (XRD) peaks at 2θ=25.6°±0.5°, 30.0°±0.5°, and 31.4°±0.5° with Cu−Kα(1,2)=1.5418 Å; and
a second component comprising lithium, phosphorus, and sulfur, and having XRD peaks at 2θ=20.9°±0.5° and 31°±0.5° with Cu−Kα(1,2)=1.5418 Å.

15. The sulfide-based solid electrolyte composite of claim 14, wherein the XRD peak at 2θ=20.9°±0.5° has a peak intensity of I_{A}, and the XRD peak at 2θ=30.0°±0.5° has a peak intensity of I_{Y}, wherein I_{A}:I_{Y} is >0.

16. The sulfide-based solid electrolyte composite of claim 15, wherein 1≥I_{A}:I_{Y} >0.

17. The sulfide-based solid electrolyte composite of claim 14, wherein the XRD peak at 2θ=31°±0.5° has a peak intensity of I_{B}, and the XRD peak at 2θ=33°±0.5° has a peak intensity of I_{C}, wherein I_{B}>I_{C}.

18. A solid-state battery including an anode layer, a cathode layer, or a separator layer comprising a solid electrolyte composite, the solid electrolyte composite comprising a first component and a second component, wherein the first component has an Argyrodite structure with x-ray diffraction (XRD) peaks at 2θ=25.6°±0.5°, 30.0°±0.5°, and 31.4°±0.5°, and the second component has XRD peaks at 2θ=20.9°±0.5°, 31°±0.5° and 33°±0.5 with Cu−Kα(1,2)=1.5418 Å.

19. The solid-state battery of claim 18, wherein the solid electrolyte composite comprises lithium, sulfur, phosphorous and a halogen selected from the group consisting of Cl, Br, I, and combinations thereof.

20. The solid-state battery of claim 18, wherein the XRD peak at 2θ=20.9°±0.5° has a peak intensity of I_{A}, and the XRD peak at 2θ=30.0°±0.5° has a peak intensity of I_{Y}, and where I_{A}:I_{Y} is >0.
